(19) United States
(12) Patent Application Publication
(10) Pub. No.: US 2025/0061190 A1
(43) Pub. Date: Feb. 20, 2025

(54) Zero Trust File Integrity Protection

(71) Applicant: Virsec Systems, Inc., San Jose, CA (US)

(72) Inventors: Piyush Gupta, Jabalpur (IN); Pratik Khade, Bangalore (IN); Rohan Ahuja, Gurugram (IN)

(21) Appl. No.: 18/720,067

(22) PCT Filed: Dec. 30, 2022
(86) PCT No.: PCT/US2022/082611

§ 371 Date: Jun. 14, 2024

Related U.S. Application Data
(60) Provisional application No. 63/368,984, filed on Jul. 21, 2022.

(30) Foreign Application Priority Data
Dec. 30, 2021 (IN) 202141061833

(51) Int. Cl. G06F 21/54; G06F 21/56; G06F 21/62

(52) U.S. Cl. CPC G06F 21/54; G06F 21/566; G06F 21/6218

(57) ABSTRACT

In some embodiments, a method includes, while an operating system kernel is running, monitoring filesystem activity, in kernel mode, from the operating system kernel for matching at least one policy. If the filesystem activity matches the at least one policy, the method suspends the filesystem activity from being executed by the operating system kernel. The method further includes performing at least one responsive action to the filesystem activity matching the at least one policy.

### RELATED APPLICATIONS

This application claims the benefit of U.S. Provisional Application No. 63/368,984, filed on Jul. 21, 2022.

This application claims priority under 35 U.S.C. § 119 or 365 to Indian Provisional Application No. 202141061833, filed Dec. 30, 2021.

The entire teachings of the above applications are incorporated herein by reference.

### BACKGROUND

In field of computing, bad actors use malware such as viruses or malware to perform damage to computing systems. With malware, bad actors can steal data, or coerce payments in exchange for returning data or control of systems.

### SUMMARY

In some embodiments, a method includes, while an operating system kernel is running, monitoring filesystem activity, in kernel mode, from the operating system kernel for matching at least one policy. If the filesystem activity matches the at least one policy, the method suspends the filesystem activity from being executed by the operating system kernel. The method further includes performing at least one responsive action to the filesystem activity matching the at least one policy.

In some embodiments, the method further includes, in user mode memory, analyzing filesystem activity from the operating system kernel and generating at least one additional policy, sending the at least one additional policy to a memory storing the at least one policy, and monitoring the filesystem activity based on the at least one policy and the at least one additional policy.

In some embodiments, the at least one responsive action includes entering write protect mode, the write protect mode preventing the filesystem activity matching the at least one policy from writing to the filesystem.

In some embodiments, the at least one responsive action includes activating an append only mode, the append only mode preventing deletion of log files and only allowing new entries to the log files.

In some embodiments, the at least one responsive action includes logging the filesystem activity matching the at least one policy.

In some embodiments, the at least one responsive action includes entering a save-attempted-write or copy-on-write mode. The method further includes copying contents of a destination memory address of the file system activity to a quarantine area of memory, performing the write in the quarantine area of memory, and analyzing the quarantine area of memory for malicious activity. If malicious activity is detected, the method rejects the filesystem activity. If malicious activity is not detected, the method allows the write to be performed in the filesystem.

In some embodiments, the at least one responsive action includes a honeypot mode. In the honeypot mode, the processor is further configured to detect an access to a honeypot file, the honeypot file being created to emulate a target of malware. The processor is further configured to copy contents of the honeypot file to a quarantine area of memory. The processor is further configured to perform the write in the quarantine area of memory. The processor is further configured to analyze the quarantine area of memory for malicious activity. If malicious activity is detected, the method rejects the filesystem activity. If malicious activity is not detected, the method allows the write to be performed in the filesystem.

In some embodiments, the file system is at least one of a cache, a memory, a hard disk, an external memory, an external hard drive, or a network-based memory.

In some embodiments, the policies include at least one of command line usage, memory interactions, process lineage, privilege use, script analysis, file access privileges, registry access, system calls, and a peripheral device.

In some embodiments, the operating system kernel is being run by a processor, the processor executing the filesystem activity and monitoring the filesystem activity.

In some embodiments, the method further includes determining a policy based on filesystem activity and its relationship to applications.

In some embodiments, a system includes a processor and a memory with computer code instructions stored thereon. The processor and the memory, with the computer code instructions, are configured to cause the system to, while an operating system kernel is running, monitor filesystem activity, in kernel mode, from the operating system kernel for matching at least one policy. If the filesystem activity matches the at least one policy, the processor is configured to suspend the filesystem activity from being executed by the operating system kernel and perform at least one responsive action to the filesystem activity matching the at least one policy.

In some embodiments, a person of ordinary skill the art can recognize that the system can execute embodiments of the above methods.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram illustrating example embodiments of monitored process and system behavior and recommendations.

FIG. 2 is a block diagram illustrating an example embodiment of the ZTFIP system.

FIG. 3 is a diagram illustrating a ZTFIP System Architecture that describes the various subsystems and modules in different stages of operations.

FIG. 4A is a diagram illustrating an example embodiment of the present disclosure for a windows environment.

FIG. 4B is a diagram illustrating an example embodiment of the present disclosure in a Linux environment.

FIG. 5 is a diagram illustrating categories of various threats.

FIGS. 6A-F are respective diagrams illustrating features of ZTFIP.

FIG. 7 illustrates a computer network or similar digital processing environment in which embodiments of the present invention may be implemented.

FIG. 8 is a diagram of an example internal structure of a computer (e.g., client processor/device or server computers) in the computer system of FIG. 5.

### DETAILED DESCRIPTION

A description of example embodiments follows.

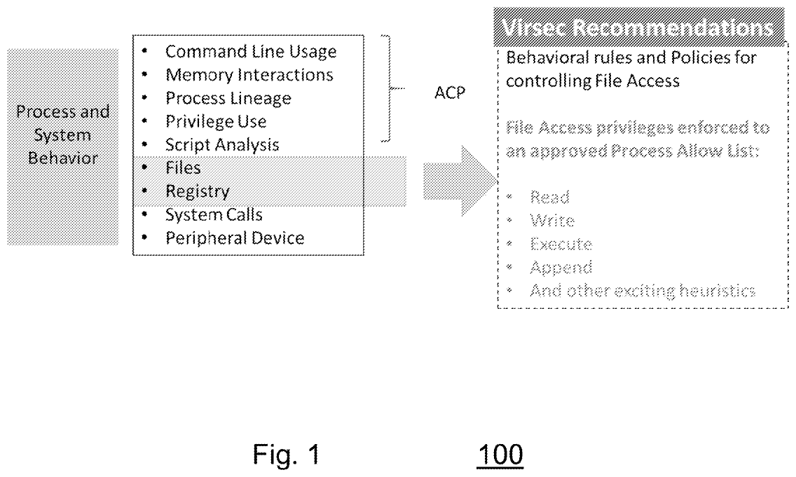

FIG. 1 is a diagram 100 illustrating example embodiments of monitored process and system behavior and recommendations. In some embodiments, a Zero Trust File Integrity Protection (ZTFIP) implements recommendations or best practices for protecting File System objects on a compute instance located in a cloud or an on-premises data center. Examples of recommendations include focusing on hardening the operating system (OS) and run time libraries running on the compute instance and focusing on enforcing best practices for running a given data center application securely. Typically, the recommendations on compute instances are applicable across the File System, whereas recommendations for using a given application file system geometry securely are specific to a given application. Recommendations may span actions on the file system and/or the various processes running on the compute instance being protected.

On detecting an attack, the ZTFIP communicates with a protection engine (e.g., the Virsec Protection Engine) and within microseconds, triggers one or more customer provided callbacks or Virsec recommendations that mitigate the ill effects of the attack.

Disclosed herein is an outline of the design of some embodiments of the present system and method, ZTFIP, that detects and performs protection actions based on file integrity (FI) events. This disclosure addresses the following two major conditions: (1) ZTFIP executes policies based on the file CRUD events on the platform in Zero Dwell Time and (2) guarantees and ensure that no file system operation goes through until the ZDT Policies are executed.

The persistence of malwares on disk is important for the malware to do horizontal and lateral movement or damage to the system. Malwares target customer data artifacts (e.g., mission critical files) to gain control and perform next stage of threat chain. Classical examples of such a class of malware include Solarwinds (Sunburst), Bad Rabbit, etc., Files-Data is a key for most of the organization, and therefore should be a priority for protection and security. Executables contents are monitored by HMM, but all other files present a vulnerable attack surface can lead to:
a) Live Off the Land Attacks (abuse of system tools),
b) Ransomware Attacks,
c) Unauthorized Config Changes,
d) Log Manipulation to hide malicious activity,
e) DBD DriveByDownload Attacks (Downloading Malicious Files), and/or
f) Unauthorized File Changes

Files and directories are high value objects that malware utilizes to stay uncovered and undetected in many scenarios, so these objects are targeted by classes of exploits and malware. Virsec ZTFIP (Zero Trust File Integrity Protection) solution mitigates attacks and protects the file system objects in fully deterministic way in Zero Dwell Time. ZTFIP can be configured to protect workloads with a spectrum from Internet of Things (IoT) to Enterprise applications (e.g., on premise/Cloud) and container workloads out of box because of the way ZTFIP is designed.

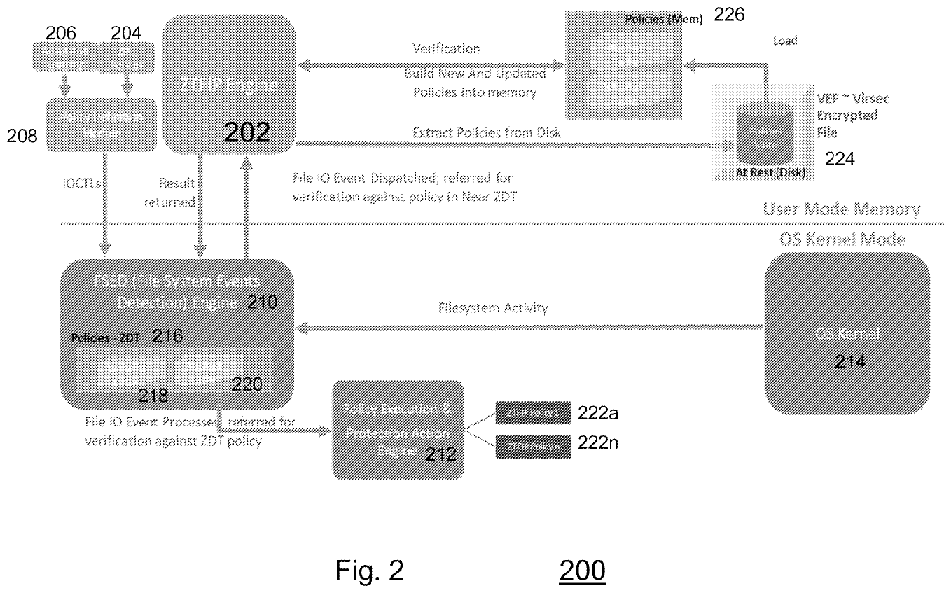

FIG. 2 is a block diagram 200 illustrating an example embodiment of the ZTFIP system. A ZTFIP Engine 202 is a ring3 (e.g., user mode) subsystem that receives and validates the file system (FS) events from the FSEDP (File System Event Detection Protection) Engine 210 from the operating system kernel 214. The ZTFIP Engine 202 in user mode validates the events with the ZDT policies 204 defined by either the manufacturer (e.g., Virsec) or the user/customer. The ZTFIP Engine 202 can be configured out of box to monitor/protect mission critical data/resources with its Zero Trust Data Protection.

The FSEDP Engine 210 is a file system detection sensor that detects file system events in real time and dispatches to ZTFIP Engine when running in Non-ZDT (Zero Dwell Time) mode, as set by the Zero Dwell Time Policies 204. In case of ZDT (Zero Dwell Time) mode, policies 216 are provisioned within FSEDP engine 210 and when the file system events are received, these events are processed through ZDT policies 204 and actions are taken in ZDT.

The ZDT Policies Module 204 defines and constructs the ZDT policies based on the Customer/Virsec default and custom definitions on what file system object and resources are to be monitored and protected by ZTFIP engine 202. Once these ZDT Polices 204 are defined, they are provisioned in the ZDFIP Kernel module and are executed based on the file system events.

An adaptive learning module 206 provides adaptive mode policy tuning that is responsible for enhancing the policies by exercising and discovering the applications and their file system relationship. By this training or tuning, applications can have much finer controlled policies around their File System actions.

The ZTFIP Engine 202 receives events from the FSED Engine 210, which monitors the file system of the kernel 214 against a plurality of ZTFIP Policies 222a-n using a policy execution and protection action engine 212. The FSED can then return events and the policies triggered 222a-n to the ZTFIP engine 202.

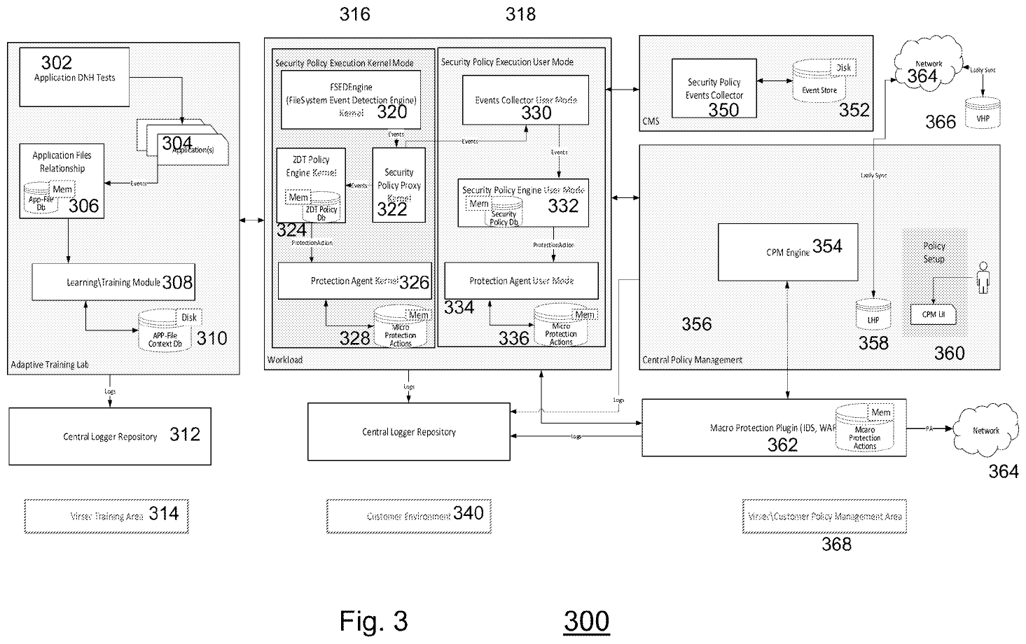

FIG. 3 is a diagram 300 illustrating a ZTFIP System Architecture that describes the various subsystems and modules in different stages of operations.

ZTFIP system architecture comprises following components:

Adaptive Training Area (Optional): In some embodiments, in the Adaptive Learning Area/Lab, Targeted Applications 304 are exercised by an Application DNH Test module 302 to determine Files 306 being accessed by the Application. Once the (Application, Files) association is determined, this becomes baseline trained data for the Application(s) 304. This baseline data can be stored on the disk 310. App-Files data set is used to define the ZTFIP Security policies. The learning/training module 308 can perform periodic training and provide data for defining more policies around the Applications. The Central Logger Repository 312 an receive logs of all events occurring in the lab, so that training can be performed.

ZTFIP: In ZTFIP subsystem is Two Layer architecture, with Kernel Mode 316 and User Mode 316. ZTFIP kernel mode provides the ZDT (Zero Dual Time) capability, where an FSEDEngine (FileSystem Event Detection Engine) 320 collects events in the kernel and a ZDT Policy Engine 324 executes policies in kernel in real time. These policies are defined based on the ZTFIP modes, described in further detail below. When executed, a protection agent 326 determines the Protection Actions to be executed.

In User Mode scenario, an events collector/event detection engine 330 dispatches the File System event to a security policy proxy 322 to determine whether to execute ZDT Kernel 326 or Security Policy User 334 mode. Event is further dispatched to protection agent user mode module 334 for policy execution, once the policy is executed the Protection Action is triggered through Protection Agent 334.

Policy Management Area: ZTFIP Policies are constructed and defined in the Policy Management Area 368 (e.g., central policy management). Policies are defined through a CPM UI 360 and stored in the LHP (Local Hardening Policy) database 358. Periodically, these policies are updated in the workload in the maintenance window.

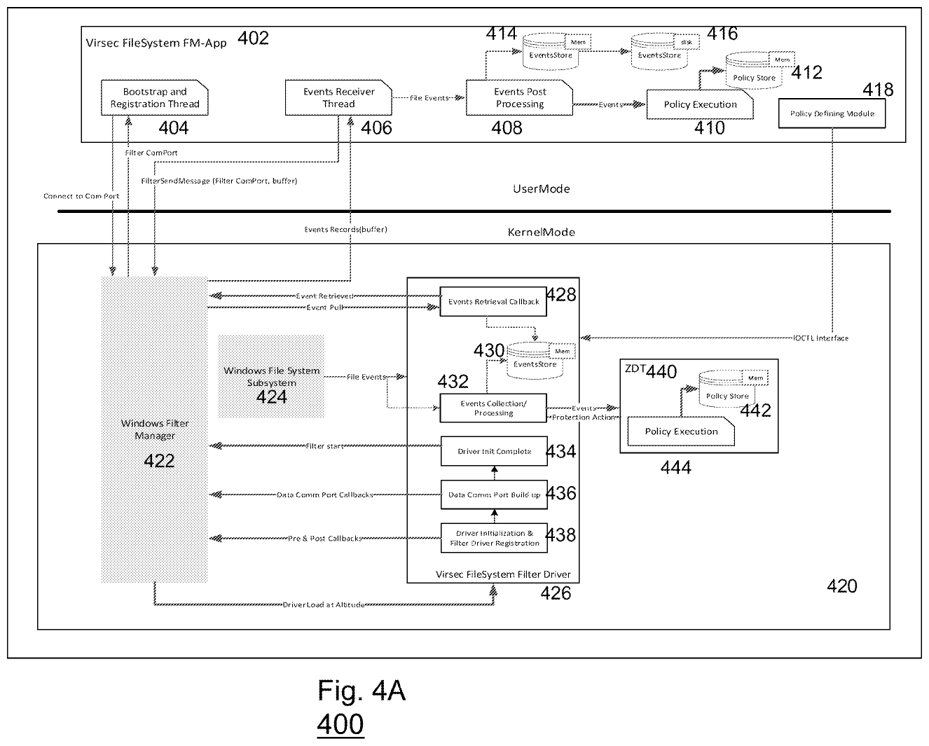

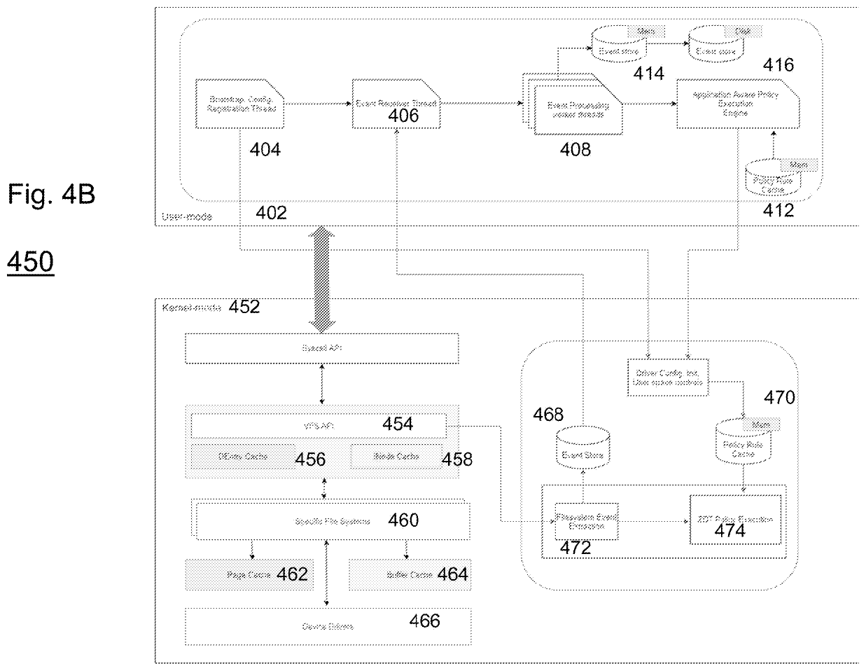

FIG. 4A is a diagram illustrating an example embodiment of the present disclosure for a windows environment. FIG. 4A illustrates the interface between user mode (UserMode) and kernel mode (KernelMode). A file system app 402 includes several modules for interfacing with the kernel 420. A bootstrap and registration thread module is configured to connect to a communication port in the windows filter manager 422 of the kernel 420, and the windows filter manager 422 responds with a filter communication port back to the bootstrap and registration thread module. An events receiver thread module 406 then sends a FilterSendMessage command with the Filter communication port and a buffer as an argument, and the Windows Filter Manager 422 responds with an events record that records to that buffer. The events receiver thread 406 then processes file events from the buffer and forwards them to an events post processing module 408. The events post processing module 408 stores the events in an event storage memory 414 and on a disk 416. The events post processing module 408 further sends the events to a policy execution module 410, which compares the events to policies in a policy store 412.

In some embodiments, in the kernel 420 the file system filter driver 426 is initiated after a driver load signal from the windows filter manager 422 by a driver initialization and filter driver registration module 438 that sends pre- and post-callbacks to the windows filter manager. The file system filter driver 426 further is initiated by a data communications port build up module 436 that sends data communication port call backs to the windows filter manager 422. A driver initialization complete module 434 sends a filter start event to the windows filter manager 422 to start the filtering process.

In the kernel 420, the windows filter manager 422 additionally communicates with a file system filter driver 426 (e.g., Virsec FileSystem Filter Driver). An events retrieval callback module 428 receives the windows filter manager's event pull request and responds with an event retrieved event and data by accessing and writing to an events store database in memory 430. A windows file system subsystem 424 further forwards file events to an events collection/processing module 432 that stores the events in the event store 430. The events collection/processing module 432 further sends events to the ZDT 440 to load relevant policies from the policy store 442 by a policy execution module 444. In turn, protection action can be sent back to the events collection/processing module 432.

In some embodiment, the Internal ZTFIP architecture in Windows is based on the FileSystem Minifilter Driver 426, which is a kernel module 520. FileSystem Events Detection is performed by the Minifilter Driver, which intercepts the FileSystem events and executed ZDT Policies in case of the IN-LINE Detection and Protection, and otherwise dispatches to ZTFIP User Mode module which will execute the policies based on the NearZDT class of policies for the monitored FileSystem Objects and resources. ZDT Policies execution Guarantees and Enforces that no FileSystem Operation is executed until the policies are executed with associated Protection Actions.

FIG. 4B is a diagram 450 illustrating an example embodiment of the present disclosure in a Linux environment. The user mode 402 includes similar elements and internal structure to user mode 402 of FIG. 4A, but communicates with different corresponding elements in the Kernel Mode 452.

In some embodiments, ZTFIP is provided by two modules in Linux OS. FSED Driver is responsible for instrumenting Virtual File System API 454 calls. The kernel mode 452 further receives compiled ZDT policies for policy enforcement in Kernel from the application aware policy execution engine 416 via the policy rule cache 412 of the user mode 402 via an IOCTL interface. Filesystem Event extraction module 472 gathers events from the VFS API 454 based on resources of interest identified by policy rule cache 470. The filesystem event extraction module/thread 472 queues all the events to event store 468 (e.g., synchronous eventing, asynchronous eventing) and to ZDT policy execution thread 474 (e.g., ZDT policy enforcement).

User space 402 ZTFIP process is responsible for compiling policy rules to policy rules cache 412. The user space 402 further identifies ZDT policy rules and configures FSED with policy and provisioning details (optionally). This user space process 402 can also manage quarantine area(s) and communicate with CMS to notify incidents. ZTFIP process can be responsible for storing filesystem access events in different modes described further below, but before describing the different modes, it is useful to describe the threat types that can be presented to the system.

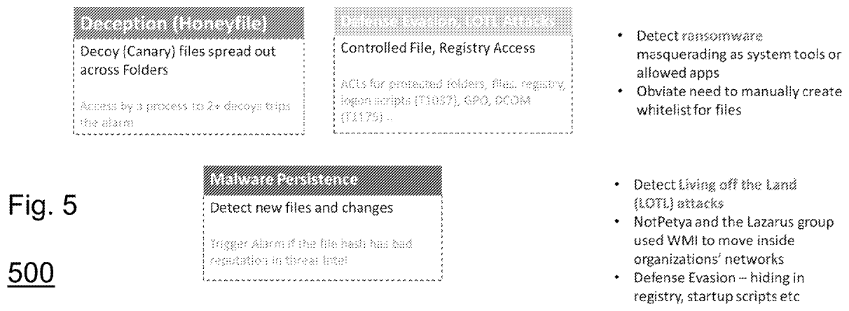

FIG. 5 is a diagram 500 illustrating categories of various threats. A first threat is a ransomware attack 502 (e.g., MITRE ATT&CK T1486). Ransomware attempts to encrypt sensitive application data or the critical system files such as the master boot record (MBR) to disrupt the availability of the system. ZTFIP carefully places decoy files (e.g., honeypot, honeyfile 502) across the system with traits similar to the adjacent files and denies read-write on it. As soon as any ransomware process accesses the honeypot file 502, ZTFIP enforces the defined policies-suspending, killing, quarantining, or taking defined custom action on the malicious process in zero-dwell time. In such a manner, the system can bait the ransomware to take action on a critical file with no risk to the system because the honeypot file 502 is merely a decoy.

A second threat is malware persistence 506, such as lateral movement (e.g., MITRE ATT&CK TA0003). Post exploitation, malware attempts to persist the access to the system across system upgrades, restarts, change of credentials, etc. The malware attempts to modify, hijack existing code, add start-up code, create/modify user accounts, or add/alter authorized keys. Any action as mentioned above requires a modification of a critical file that ZTFIP can flag on the unauthorized access.

A third threat is live off the land attacks/defense evasion 504 (MITRE ATT&CK TA0005). ZTFIP embodiments mitigate the effects of the live off the land attacks, where the exploit tends to become persistent to the Disk. ZTFIP in real time detects and prevents or secures the folder file objects which are used by Malware and Exploits to become persistent to the secondary storage through FileSystem interfaces.

A fourth threat is unauthorized configuration changes to the system and applications. ZTFIP can prevent any unauthorized access of the configs as it has an allow list access control validation. As such, only allowed processes with the valid access controls can access the files.

A fifth threat is log manipulation to hide malicious activity. ZTFIP can monitor and prevent any unauthorized access on any file on the system. The default allow list enforces a deny-read-write policy on the critical system files such as the event logs, kernel messages for any process apart from the allowed process. In addition, AAFIP enforces the default append-only policy for all the allowed processes writing the logs.

A sixth threat are real-time alerts that reduce dwell time of an attacker. The deterministic, zero-dwell time kernel implementation allows AAFIP to send real time alerts. This proactive approach does not allow the malicious process or file to dwell on the system as compared to the reactive approaches where the protection engine applies learning on a sequence of events before sending an alert.

In the section that follows, embodiments of compliance strategies are described. A person of ordinary skill in the art can recognize that these strategies can be employed alone or in combination with each other, or in combination with the other methods and systems disclosed.

File Integrity Assurance. ZTFIP can monitor and protect the files across the system in real-time. Any access on the file is allowed or denied based on the policy enforced by the customers. Hence, only the legitimate processes and/or users can perform operations on the file system assuring the file integrity across the host.

Configuration Integrity Assurance. By default, ZTFIP enforces Write Protected Policy on all the sensitive and critical configuration files defined on the maintenance window. Any attempt to write on these files is reported and thwarted in real time. In this way, ZTFIP assures the configuration integrity post the maintenance window.

Log Integrity Assurance (allow append only). The default policy allows the log files to be written in append-only mode. ZTFIP enforces this policy on the processes that are part of the allow list to ensure the log integrity. This also prevents any misuse of the logs by the attackers for removing the footprints.

Forensics, Reporting and Remediation. In some embodiments, ZTFIP follows the syslog format and can report access on every file, based on the policy. This enables forensics, diagnosis, and remediation of any fault. Moreover, the real-time reporting allows any SORE or SIEM tool to ingest the events and respond based on the defined playbooks.

Regulatory Compliance (PCI DSS, SANS CSC). ZTFIP ensures and helps enforce any data security compliance like PCI DSS and SANS CSC. ZTFIP ensures that data is only accessed by legitimate processes and users and makes a secure environment to store sensitive data.

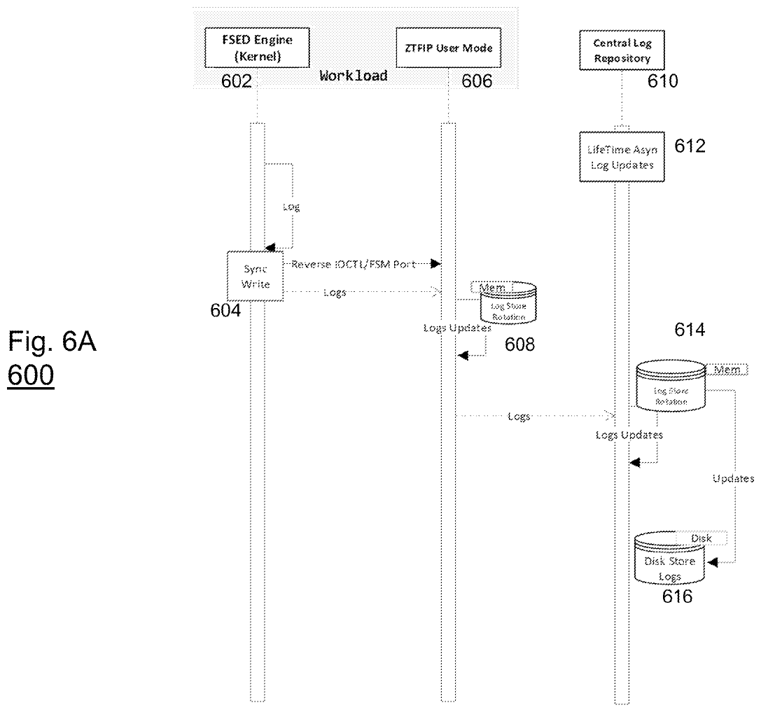

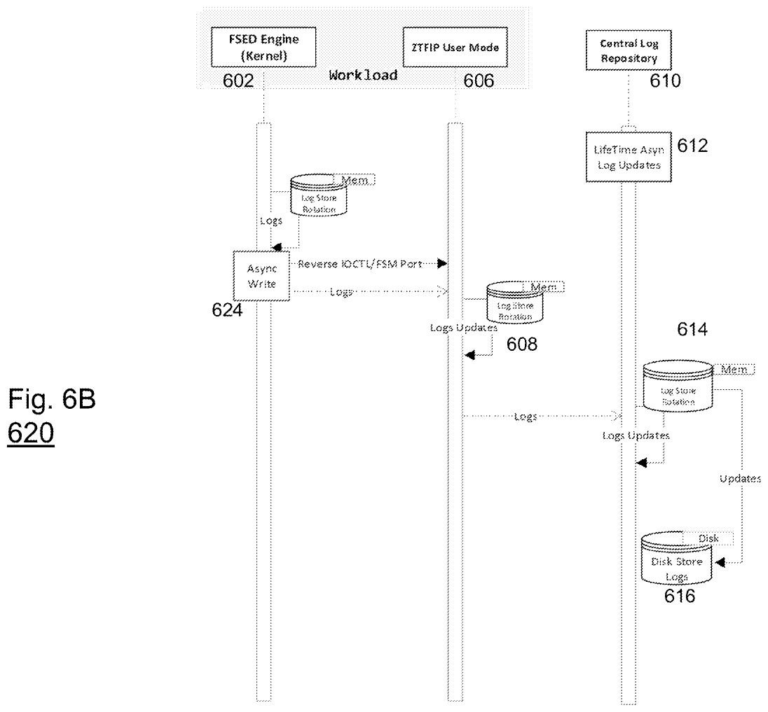

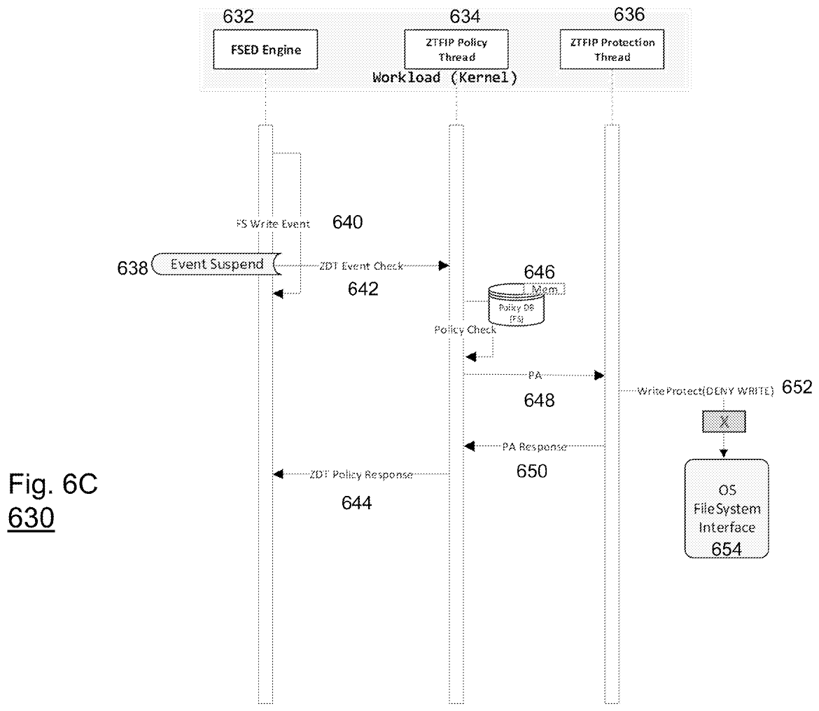

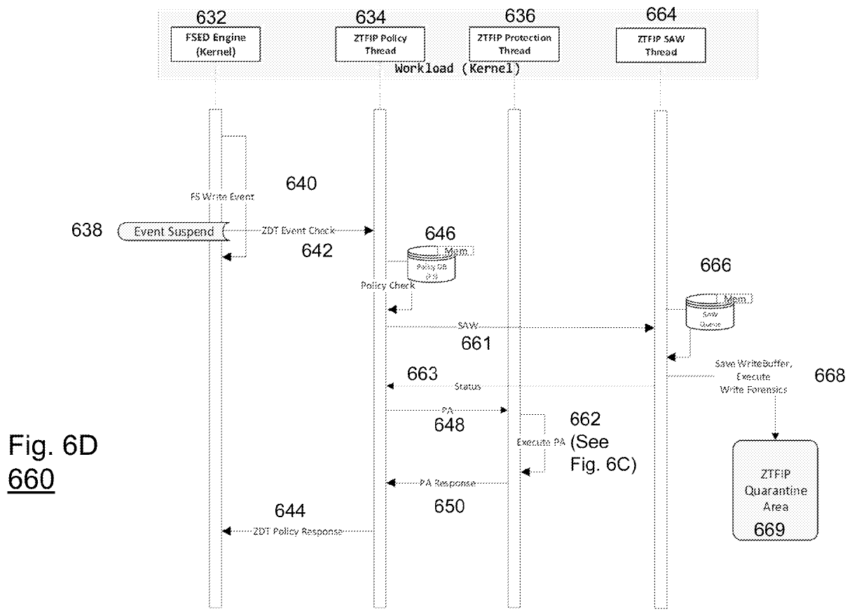

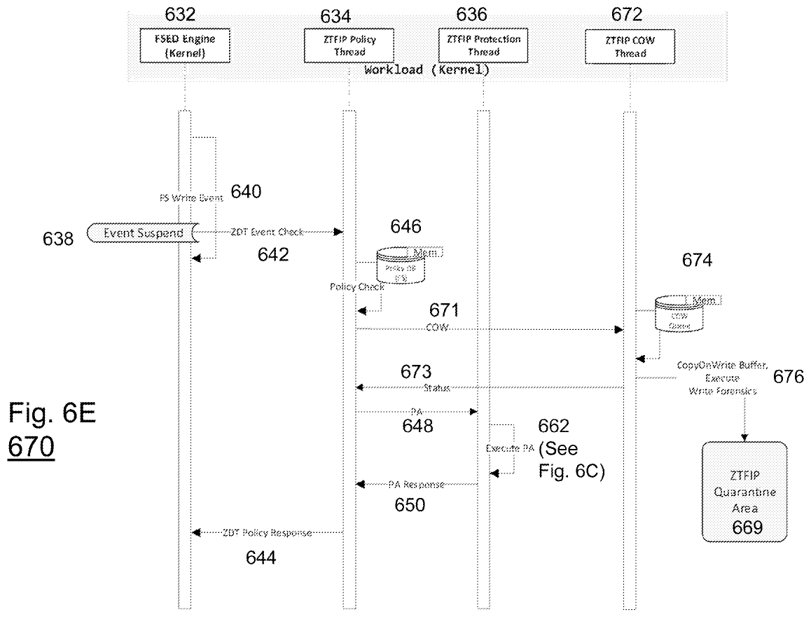

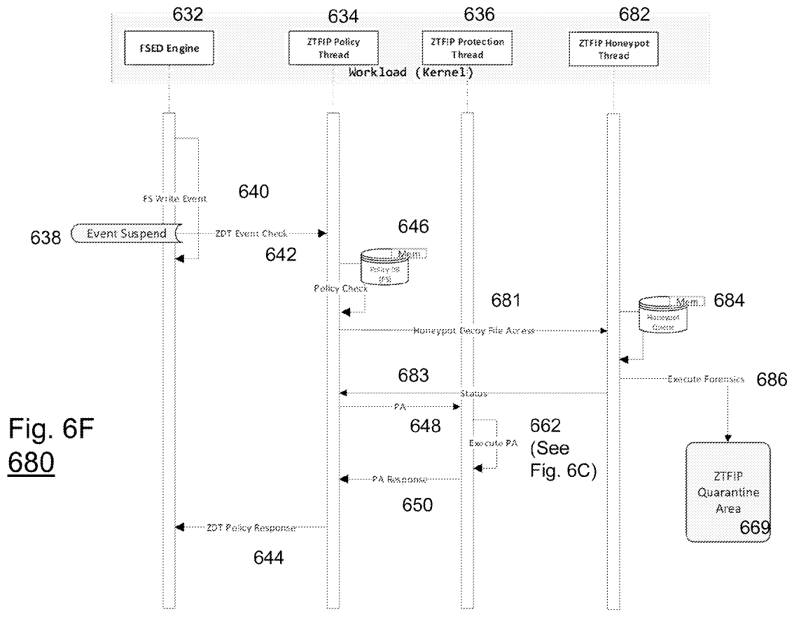

FIGS. 6A-F are respective diagrams 600, 620, 640, 660, 680, 690 illustrating features of ZFTIP.

FIG. 6A is a diagram 600 illustrating an example embodiment of synchronous eventing employed by the present disclosure. Synchronous eventing mode provides real-time file system access events to the user. ZTFIP is capable of reporting accesses (read/write/execute) to critical artifacts on application servers and OS specific system configuration files. This feature can be available out of box and only requires identification of critical system artifacts. The OS specific configuration files are availed from VHP (e.g., Virsec Cloud DB). For gathering synchronous events, ZTFIP FS Sensor Engine 602 (e.g., kernel) extracts FS access events to mission critical artifacts. A kernel 602 side synchronous write module 604 logs these FS access events over a reverse IOCTL/FSM port to a ZTFIP user mode 606 in a log store rotation memory 608. This log store rotation can be a rotating queue, in some embodiments. For more permanent storage, these events can be further logged in a central log repository 610 (e.g., via log store rotation memory 614 and disk store logs 616, for even longer storage) and can trigger an alert in case of access violation based on ACP. The central log repository 610 provides a lifetime synchronous log update capability.

FIG. 6B is a diagram 620 illustrating an example embodiment of asynchronous eventing employed by the present disclosure. Asynchronous eventing structure is similar to the modules of FIG. 6A, except that asynchronous write module 624 is employed in place of the synchronous write module 604.

FIG. 6C is a diagram 630 illustrating an example embodiment of a policy write event processing blacklist as employed by the present disclosure. ZTFIP provides ZDT protection to mission critical system resources by following black-list based access control lists (ACLs). Some processes in a system should never access system resources or OS configuration files. ZTFIP provides different modes to mitigate various types of attacks. ZTFIP can segregate groups of resources and allowed processes that can access those resources. ZTFIP also can provide blacklist-based protection to client configured FS resources.

A FSED Engine 632 in the kernel first detects a FS write event 640, triggering an event suspension 638. While the event is suspended, the FSED engine 632 issues a ZDT event check 642 to a ZTFIP policy thread 634. The ZTFIP Policy Thread 634 performs a policy check using the policy database 646 in memory. Once the policy is loaded, it is sent 648 to the ZTFIP protection thread 636. If the thread 636 determines that a resource should be protected, it initializes a write protect 652 and denies a write to the operating system's file system interface 654. Otherwise, it allows the write. The thread 636 then issues a response status 650 to the ZTFIP policy thread 634. The ZTFIP policy thread 634 issues a ZDT policy response 644 to the FSED engine 632.

FIG. 6D is a diagram 660 illustrating an example embodiment of a save attempted write (SAW) employed by embodiments of the present disclosure. FIG. 6D includes many similar elements of FIG. 6C (see, e.g., Executing the PA 662). One addition to FIG. 6D is a ZTFIP save attempted write (SAW) thread or module 664.

The FSED Engine 632 can identify attempted writes to write protected files with a SAW request 661. The FSED engine 632 maintains a state in runtime FS data-structure to identify a protected resource. The FSED engine 632 therefore triggers a ZTFIP SAW thread 664 when a blacklisted/unidentified process attempts to write to a protected resource. In such an instance, all of the writes in the write request can be saved in a separate internal buffer 666 and could be saved 668 to ZTFIP quarantine area 669 for forensic analysis. After the SAW, the ZTFIP Saw thread 664 returns a status 663.

FIG. 6E is a diagram 670 illustrating an example embodiment of a copy on write (COW) employed by embodiments of the present disclosure. FIG. 6E includes many similar elements of FIG. 6C (see, e.g., Executing the PA 662). One addition to FIG. 6E is a ZTFIP copy attempted write (CAW) thread or module 674.

The FSED Engine 632 can identify attempted write to write protected files. In such scenarios, it maintains a state in runtime FS data-structure to identify a protected resource via the policy check 646. Such an identification triggers COW thread 672 when a blacklisted/unidentified process attempts to write to a protected resource. In this mode, the COW thread 672 gathers all the writes in a COW queue 674 and saves 676 a copy of original resources to ZTFIP quarantine area 669. This allows users to restore critical files in case of unintentional amendments to those resources, while still seeing the outcome of those write operations.

FIG. 6F is a diagram 680 illustrating an example embodiment of a honeypot protection scheme employed by embodiments of the present disclosure. FIG. 6F includes many similar elements of FIG. 6C (see, e.g., Executing the PA 662). One addition to FIG. 6F is a ZTFIP Honeypot thread or module 674.

FSED Engine 632 detect the FileSystem access on the Decoy objects, which are placed across the monitored FileSystem Directories. Then, the policy thread 634 identifies the honeypot region and mode based on the FileSystem event context 642. Subsequently, policy engine/thread 634 triggers 681 the ZTFIP honeypot thread 682, which processes the event and determines the protection actions based on the defined protection actions (PAS) 648 for the given event.

A decoy file can be intelligently constructed to reflect the normal file present on the monitored applications. Some of the factors that can be included while defining the decoy files in real time are FileType classifications, File Size and File Timestamp, etc. Based on the analysis of this context on the Monitored Application locations, Decoy file can be formed and placed accordingly. Once the Honeypot file access is detected, then ZTFIP can further analyze Caller Process, Notify the Subscriber on the event along with Context etc.

Further, the honeypot file accesses can be stored in the honeypot queue 686 and executed in the ZTFIP Quarantine area 688 for forensic analysis.

### ZTFIP Unique Value Proposition

ZTFIP enforces the “Zero Trust” principle on file operations, which ensures the monitoring of customers' critical assets (e.g., FileSystem Objects such as OS configuration files, customer's artifacts, etc.) by protecting them at runtime. ZTFIP subjects every file operation to a set of policies and performs inline (Zero Dwell Time) protection actions. The distinct features of ZTFIP are described further below, according to some embodiments alone or in combination:

### ZTFIP Modes

ZTFIP modes provide inline protection and help in analyzing and discovering zero-day exploits. In addition, it provides tools for performing runtime forensics. ZTFIP enforces the INLINE policies execution and protection by, suspending the file operations of the monitored file system objects and executing the policies associated with FileSystem objects. The ZTFIP modes are Write Protect (WP), Append Only (AO), Copy on Write (COW), Save Attempted Write (COW), and Honeypot. These modes are described in further detail below.

### ZTFIP WP (WriteProtect) (FIG. 6C)

ZTFIP WP (WriteProtect) mode prevents malicious or unauthorized writing on files and directories of interest. WP mode guarantees the fully deterministic control of the file operation on the monitored FileSystem objects such as files and directories.

### ZTFIP AO (AppendOnly)

The ZTFIP AO (AppendOnly) mode enforces the writing of log files in the append mode. This mode prevents the tampering of the logs by the attackers for clearing the footprints post-exploitation.

### ZTFIP COW (CopyOnWrite)/SAW (SaveAttemptedWrite) (FIGS. 6D-E)

The COW (CopyOnWrite)/SAW (SaveAttemptedWrite) modes capture and analyze the data written to the FileSystem Objects in the INLINE/ZDT (Zero Dwell Time) mode. These modes can perform inline forensics and protection actions to completely mitigate any malicious activities on the FileSystem.

### ZTFIP Honeypot (FIG. 6F)

This mode provides distinct capabilities to watch the monitored FileSystem Objects by placing the decoy files. These decoy files are carefully created by analyzing the adjacent file attributes such as file extensions, headers, type, etc. ZTFIP enforces decoy files with a “deny-read-write” policy, so any operation performed on the file triggers the execution of protection action on the process. This mode ensures the mitigation of the ransomware exploits that intends to perform file operations and encrypt the critical FileSystem objects.

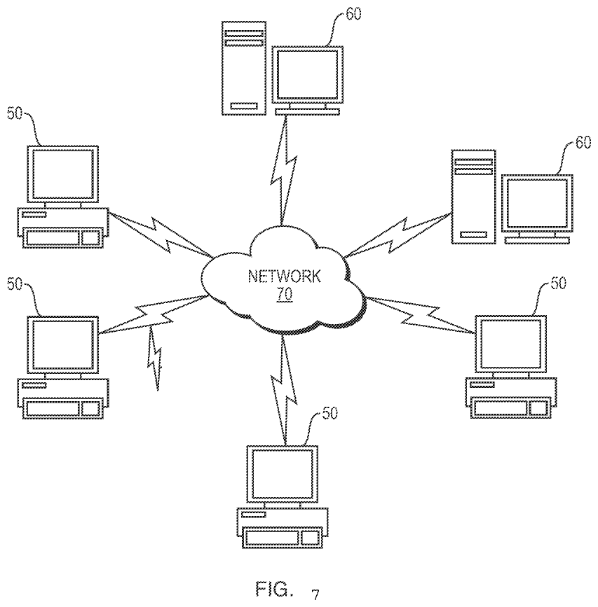

FIG. 7 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

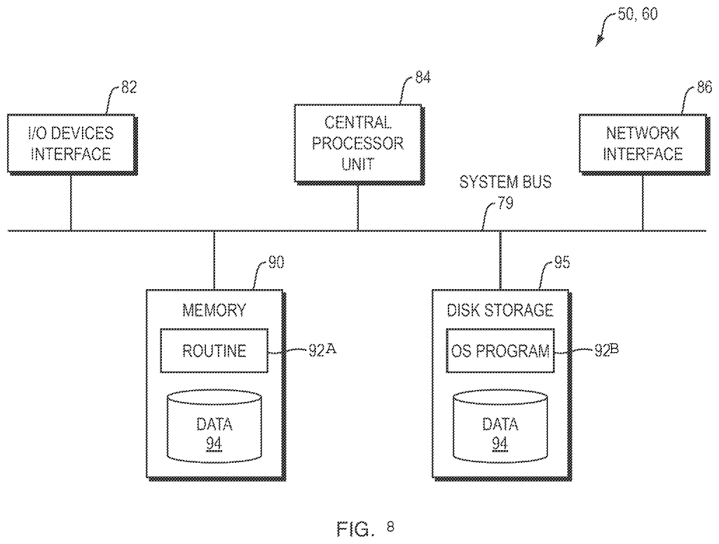

FIG. 8 is a diagram of an example internal structure of a computer (e.g., client processor/device 50 or server computers 60) in the computer system of FIG. 5. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 7). Memory 90 provides volatile storage for computer software instructions 92 and data 94 used to implement an embodiment of the present invention (e.g., OS Kernel, ZTFIP Engine, FSED Engine, Policy Definition Module, Adaptive Learning Module, Protection Action Engine, Policy Execution and Protection Action Engine modules detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method comprising:
while an operating system kernel is running, monitoring filesystem activity, in kernel mode, from the operating system kernel for matching at least one policy;
if the filesystem activity matches the at least one policy, suspending the filesystem activity from being executed by the operating system kernel; and
performing at least one responsive action to the filesystem activity matching the at least one policy.

2. The method of claim 1, further comprising:
in user mode memory, analyzing filesystem activity from the operating system kernel and generating at least one additional policy;
sending the at least one additional policy to a memory storing the at least one policy;
monitoring the filesystem activity based on the at least one policy and the at least one additional policy.

3. The method of claim 1, wherein the at least one responsive action includes entering write protect mode, the write protect mode preventing the filesystem activity matching the at least one policy from writing to the filesystem.

4. The method of claim 1, wherein the at least one responsive action includes activating an append only mode, the append only mode preventing deletion of log files and only allowing new entries to the log files.

5. The method of claim 1, wherein the at least one responsive action includes logging the filesystem activity matching the at least one policy.

6. The method of claim 1, wherein the at least one responsive action includes entering a save-attempted-write or copy-on-write mode, further comprising:
copying contents of a destination memory address of the file system activity to a quarantine area of memory;
performing the write in the quarantine area of memory; and
analyzing the quarantine area of memory for malicious activity, and if malicious activity is detected, rejecting the filesystem activity, and if malicious activity is not detected, allowing the write to be performed in the filesystem.

7. The method of claim 1, wherein the at least one responsive action includes a honeypot mode, wherein the honeypot mode further includes:
detecting an access to a honeypot file, the honeypot file being created to emulate a target of malware;
copying contents of the honeypot file to a quarantine area of memory;
performing the write in the quarantine area of memory; and
analyzing the quarantine area of memory for malicious activity, and if malicious activity is detected, rejecting the filesystem activity, and if malicious activity is not detected, allowing the write to be performed in the filesystem.

8. The method of claim 1, wherein the file system is at least one of a cache, a memory, a hard disk, an external memory, an external hard drive, or a network-based memory.

9. The method of claim 1, wherein the policies include at least one of command line usage, memory interactions, process lineage, privilege use, script analysis, file access privileges, registry access, system calls, and a peripheral device.

10. The method of claim 1, wherein the operating system kernel is being run by a processor, the processor executing the filesystem activity and monitoring the filesystem activity.

11. The method of claim 1, further comprising determining a policy based on filesystem activity and its relationship to applications.

12. A system comprising:
a processor; and
a memory with computer code instructions stored thereon, the processor and the memory, with the computer code instructions, being configured to cause the system to:
while an operating system kernel is running, monitor filesystem activity, in kernel mode, from the operating system kernel for matching at least one policy;
if the filesystem activity matches the at least one policy, suspend the filesystem activity from being executed by the operating system kernel; and
perform at least one responsive action to the filesystem activity matching the at least one policy.

13. The system of claim 12, wherein the processor is further configured to:
in user mode memory, analyzing filesystem activity from the operating system kernel and generating at least one additional policy;
sending the at least one additional policy to a memory storing the at least one policy;
monitoring the filesystem activity based on the at least one policy and the at least one additional policy.

14. The system of claim 12, wherein the at least one responsive action includes entering write protect mode, the write protect mode preventing the filesystem activity matching the at least one policy from writing to the filesystem.

15. The system of claim 12, wherein the at least one responsive action includes activating an append only mode, the append only mode preventing deletion of log files and only allowing new entries to the log files.

16. The system of claim 12, wherein the at least one responsive action includes logging the filesystem activity matching the at least one policy.

17. The system of claim 12, wherein the at least one responsive action includes entering a save-attempted-write or copy-on-write mode, the processor is further configured to:
copy contents of a destination memory address of the file system activity to a quarantine area of memory;
perform the write in the quarantine area of memory; and
analyze the quarantine area of memory for malicious activity, and if malicious activity is detected, rejecting the filesystem activity, and if malicious activity is not detected, allowing the write to be performed in the filesystem.

18. The system of claim 12, wherein the at least one responsive action includes a honeypot mode, wherein the honeypot mode further includes:
detecting an access to a honeypot file, the honeypot file being created to emulate a target of malware;
copying contents of the honeypot file to a quarantine area of memory;
performing the write in the quarantine area of memory; and
analyzing the quarantine area of memory for malicious activity, and if malicious activity is detected, rejecting the filesystem activity, and if malicious activity is not detected, allowing the write to be performed in the filesystem.

19. The system of claim 12, wherein the file system is at least one of a cache, a memory, a hard disk, an external memory, an external hard drive, or a network-based memory.

20. The system of claim 12, wherein the policies include at least one of command line usage, memory interactions, process lineage, privilege use, script analysis, file access privileges, registry access, system calls, and a peripheral device.

21. The system of claim 12, wherein the operating system kernel is being run by a processor, the processor executing the filesystem activity and monitoring the filesystem activity.

22. The system of claim 12, wherein the processor is further configured to determine a policy based on filesystem activity and its relationship to applications.
